(19) United States
(12) Patent Application Publication
(10) Pub. No.: US 2015/0069916 A1
(43) Pub. Date: Mar. 12, 2015

(54) KINEMATIC LIGHT CONTROL SYSTEM

(71) Applicant: 3M Innovative Properties Company, St. Paul, MN (US)

(72) Inventors: Patrick R. Fleming, Lake Elmo, MN (US); Thomas R.J. Corrigan, St. Paul, MN (US); Jun Xiao, Austin, TX (US)

(21) Appl. No.: 14/483,560

(22) Filed: Sep. 11, 2014

Related U.S. Application Data
(60) Provisional application No. 61/876,872, filed on Sep. 12, 2013.

(51) Int. Cl. H05B 37/02

(52) U.S. Cl. CPC H05B 37/0272; H05B 37/0281; H05B 37/0227
USPC 315/131

(57) ABSTRACT

The present disclosure provides a system and method for controlling spot lights, such as theater or display lights, which incorporates a handheld remote control that uses intuitive motions for selecting, positioning, dimming and other lighting setup functions. The present disclosure describes a spotlight control device, a lighting system including the spotlight control device, and a method for spotlight control. The spotlight control device incorporates a first light source that emits a first control beam that activates a desired spotlight. The activated spotlight can provide feedback to indicate that it has been activated. A second light source from the control device emits a second control beam that is used to direct the activated spotlight to an illumination region.

### BACKGROUND

Despite innovations in the field of wireless remote controls for video games, television and a host of other electronic devices, most spotlight fixtures are positioned by hand, one at a time, on a ladder, scaffolding or catwalk. Such spotlight fixtures include lighting for retail displays, museum and other art and artifact displays, theater, music and other entertainment venues. Often these spotlight fixtures are not easily accessible, and at times, the lights may be positioned directly above expensive or delicate items, making placement of a ladder difficult.

Spotlight fixtures that can be moved by remote control include such fixtures as the Varilite VL3000 Spot, available from Philips. These spotlight fixtures can be relatively expensive, large, and heavy compared to manually controlled spotlights, and are often controlled by a hard wired system designed to move the spotlights in a coordinated fashion during the show.

There is a need for an intuitive control system for compact display lighting that allows remote control.

### SUMMARY

The present disclosure describes a spotlight control device, a lighting system including the spotlight control device, and a method for spotlight control. The spotlight control device incorporates a first light source that emits a first control beam that activates a desired spotlight. The activated spotlight can provide feedback to indicate that it has been activated. A second light source from the control device emits a second control beam that is used to direct the activated spotlight to an illumination region. In one aspect, the present disclosure provides a method for spotlight control that includes pointing a control device toward a desired spotlight; activating the desired spotlight with a first control beam from the control device; pointing the control device at an illumination region; and activating the illumination region with a second control beam from the control device, wherein the activated spotlight moves to illuminate the activated illumination region.

In another aspect, the present disclosure provides a method for spotlight control that includes pointing a control device toward a desired spotlight; activating the desired spotlight with a first control beam from the control device; activating a beacon; and positioning the beacon in an illumination region, wherein the activated spotlight follows the beacon to illuminate the activated illumination region.

In yet another aspect, the present disclosure provides a spotlight control device that includes a first light source capable of emitting a first wavelength of light collimated within a first beam angle; a second light source capable of emitting a second wavelength of light; and a selector switch capable of selecting the first light source or selecting the second light source.

In yet another aspect, the present disclosure provides a lighting system that includes at least one spotlight having a first sensor filtered to detect a first narrow wavelength band of light to activate a selected spotlight; a second sensor filtered to detect a second narrow wavelength band of light incident on the selected spotlight; and a mechanism to move the selected spotlight in alignment with a light source having the second narrow wavelength band of light. The lighting system further includes a spotlight control device capable of illuminating the first sensor with the first narrow wavelength band of light and the second sensor with the second narrow wavelength band of light, wherein the light source having the second narrow wavelength band of light is in an illumination region.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings, where like reference numerals designate like elements, and wherein:

FIG. 1 shows a process schematic for controlling a spotlight;

FIGS. 2A-2C show a room containing a lighting system for controlled spotlights; and

FIGS. 3A-3B show a room containing a lighting system for controlled spotlights.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The present disclosure provides a system and method for controlling spot lights, such as theater or display lights, which incorporates a handheld remote control that uses intuitive motions for selecting, positioning, dimming and other lighting setup functions. It can take many hours to position lights, particularly overhead spotlights, by hand for a display or show. The necessary time could be cut considerably if an intuitive remote control device such as the device and system described herein was used to set up the lights.

In one particular embodiment, the remote control can incorporate a light source which the spotlight fixture is equipped to track or follow, to facilitate positioning the spotlight fixture. In some cases, the remote control can be equipped with accelerometers to detect hand motions, and these are used to control the spotlight fixture.

In yet another embodiment, a beam of light can be used to select a spotlight fixture for control. The beam of light can be narrow, but still broad enough that it can possibly impinge on several spotlight fixtures. The priority order of the several spotlight fixtures can be selected by several different schemes, including for example by activating a selection switch (perhaps multiple times) to select the desired fixture.

In the following description, reference is made to the accompanying drawings that forms a part hereof and in which are shown by way of illustration. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise. Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on” “connected to,” “coupled with” or “in contact with” another element, component or layer, it can be directly on, directly connected to, directly coupled with, in direct contact with, or intervening elements, components or layers may be on, connected, coupled or in contact with the particular element, component or layer, for example. When an element, component or layer for example is referred to as being “directly on,” “directly connected to,” “directly coupled with,” or “directly in contact with” another element, there are no intervening elements, components or layers for example.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

The lighting system incorporates a plurality of spotlight fixtures and a hand held control device for controlling the spotlight fixtures. In one particular embodiment, the control device emits a visible beam of light. The beam of light can be pointed at a spotlight fixture by the user and a switch on the control can then be activated to select that light fixture. In some cases, an indicator light on the spotlight fixture is then illuminated to let the user know the light has been selected. The beam of light from the remote can then be pointed at the illumination region where the user desires the spotlight fixture to point, and the spotlight fixture positions itself to point at that spot. Other aspects of the spotlight, such as dimming, color, beam shape, and edge sharpness, may be controlled with other switches, accelerometers, control beams, or control sequences on the control device. The spotlight fixture can then be deselected by selecting another fixture, by using the same procedure used to select the fixture, or, alternatively, after a fixed time.

In some cases, compact spotlight fixtures can be useful, such as those described in co-pending U.S. patent application based on Attorney Docket No. 71512US002, entitled CATADIOPTRIC SPOTLIGHT, filed on an even date herewith. Such compact spotlight fixtures can use a flexure bearing that requires very small movements to focus the spotlight, and are light and easily moved with small motors such as stepper motors and the like.

After a desired spotlight fixture is selected, the control device is optionally operated in another mode, referred herein as the “beacon” mode, where the control device emits a very broad beam of light. In this manner, it becomes a beacon that the desired spotlight fixture can follow. The control device can then be positioned at the illumination region where the desired spotlight fixture should illuminate, and the desired spotlight fixture points itself at the control device. The described switch from beam mode to beacon mode can be accomplished with another light source turning on, by putting a diffuser in the narrow beam of the control light source, or by removing a collimation means that is used to make the narrow beam narrow (e.g., by repositioning a reflector that places the light source at a focal point).

The described spotlight fixtures are spotlights having illumination patterns that do not necessarily include the place where the observer is. As a result, little or no light from the spotlight fixture may fall on the observer. The spotlight fixtures are meant to illuminate the scene, or region, at which the observer is looking. Consequently, the observer may not be able to discern which of a plurality of spotlight fixtures is illuminated. In one particular embodiment, some other sort of feedback to the observer is needed, so that it is known which light or lights are under control of the control device. In some cases, is can be useful to have a small indicator light or lights that illuminate when the fixture is selected. These indicator light(s) should have a much wider illumination angle than the main spotlight fixture light, but can be much lower power. The indicator light(s) can be colored, they can flash in response to changes in the condition of the fixture or in response to commands from the remote.

In one particular embodiment, an indicator light can be the preferred means of confirming selection, however other ways of confirming selection of a spotlight fixture and other command responses are also possible. In some cases, an indicator on a control panel, separate from the control, can activate in response to selecting a spotlight fixture. In response to selection, a representation of the fixture in a diagram or a photograph in a display can change. Control panels can be less preferable because they require the user to divert attention from the scene being illuminated. In some other cases, the spotlight fixture can identify itself by moving with a nodding or other small motion, it can change its color or intensity momentarily (i.e., flash) or continuously as the user adjusts the fixture, and/or audible or other wireless signals can be generated to indicate selection of the spotlight fixture.

In one particular embodiment, the spotlight fixtures are equipped with at least two light sensors for detecting the light coming from the remote. One sensor can be configured so that it can sense the light from the control device from many different directions, and can be referred to as the selection sensor. The second sensor can be a position sensitive sensor that can detect at least the direction the light source is from the center of the beam of the fixture. In some cases, this second sensor may have a smaller field of view, and it also can include position feedback. i.e., the pointing sensor. In some cases, this pointing sensor can be a quad photodiode with an imaging lens in front of it. In some cases, the pointing sensor can instead be an imaging device (e.g., a camera) with a multi-pixel sensor. In either case, both sensors should be filtered to only accept the wavelengths of light emitted by the control device, and/or should be only sensitive to the pulse frequencies emitted by the control device.

In a pointing mode, the spotlight fixture moves to align its beam with the target light from the control device. In some cases, the pointing sensor can be configured so that it senses the relative direction between the target light from the control device and the center of the beam from the spotlight fixture. This can be done, for example, by mounting the sensor to the structure that moves the spotlight fixture beam, or by detecting the target beam with an imaging device and calculating the deviation from the known position of the spotlight fixture beam. If the axes of the pointing sensor align with the motor axes of the fixture, then the control logic can become very simple. Each axis of the fixture moves until it has balanced the target beam in its field of view.

The spotlight fixtures are also equipped with means to drive the spotlight fixture along at least two axes for pointing the fixture. The fixture may also be equipped with other features that can be controlled by the control device such as dimming, color control, beam shape and size control, and beam edge sharpness control.

In one particular embodiment, the spotlight fixtures may not need to send any information to the control device, so the control device does not need any receiving sensors. In some cases, the fixtures may need to communicate with a central control device or with each other. This can be done through a wired protocol such as DMX (i.e., Digital MultipleXed protocol), or through a wireless protocol such as ZigBee (i.e., based on IEEE 802.15.4 wireless protocol), as known to one of skill in the art. A combination of wired and wireless communication can also be used between spotlight fixtures.

The control device generally is able to send information to a fixture. In one particular embodiment, this can be done by changing the light coming from the control device. The preferred change is the pulse frequency of the light in the control device. There can be a “stand by” frequency that the fixture senses to know that it is being targeted. Another frequency can be used to indicate that the fixture is being selected. Another frequency can be used in indicate that the beam from the control device is positioned where the user wants the fixture to point.

The light coming from the control device is preferably of a limited wavelength range in the visible, and the sensors on the fixture preferably have filters on them so that they detect only this desired wavelength range. In some cases, the dimensional characteristics of the beam of light coming from the control device can be important. The beam can be approximately circular and may have a brightest point in the center of the beam, with a monotonic falloff toward the edges. Such a beam can be defined by a beam angle (full width half max), a field angle (10% point) and a cutoff angle (1% point). Most users can reliably point a small handheld device to an accuracy of no better than 1 degree. In some cases, particularly for reliability, a 2 degree angle can be needed. In this case, the beam angle should be about 2 degrees, with the field angle no more than twice this (i.e., no more than 4 degrees). The cutoff angle can be as close to the field angle as possible. Any fixture within the field angle should be able to sense the beam from the control device.

Since a 4 degree angle is about 70 cm wide at 10 meter distance, and the fixtures could be spaced as close as 15 cm apart, more than one fixture could be targeted during the selection process. In order to select a single fixture at a time to put under control, the selection process decides what fixture is the most likely. In one particular embodiment, one way of selecting the one or more fixtures is that each fixture that detects the beam coming from the control device gives itself a rating based on the intensity of the light it detects. The fixtures then communicate between themselves or with another control device and the fixture or fixtures with the highest rating is selected. Thus, a temporary, hierarchical list is created. The user activates the “select” control and the top fixture on this list is activated. If this is not the fixture the user desires, the user can activate the select control again, at which time the next fixture on the list is activated. The user repeatedly activates the select control until the desired fixture is under control. The list is maintained until another control input is received from the control device, or until none of the fixtures on the list are detecting the light from the control device. This procedure describes a method of selecting one fixture at a time. Only slightly more complex procedures can select more than one fixture at a time for control, and other techniques can be used to select a desired fixture, as known to one of skill in the art.

The control device described herein is not necessarily the only control device that can be used to control the fixtures. There can be other control devices that are meant to control a large number of fixtures at once, or automated controls that allow characteristics of the light coming from the fixtures to be changed without user input, as known to one of skill in the art.

Although following a light emitted from the control device can be the preferred means of positioning the fixtures, the control device could optionally be fitted with a joystick device or similar selector switch that sends positioning information to the fixture. In this case, the control device could have a transmitter (not optical) installed to communicated wirelessly with the fixtures or with another control device that in turn communicates with the fixtures.

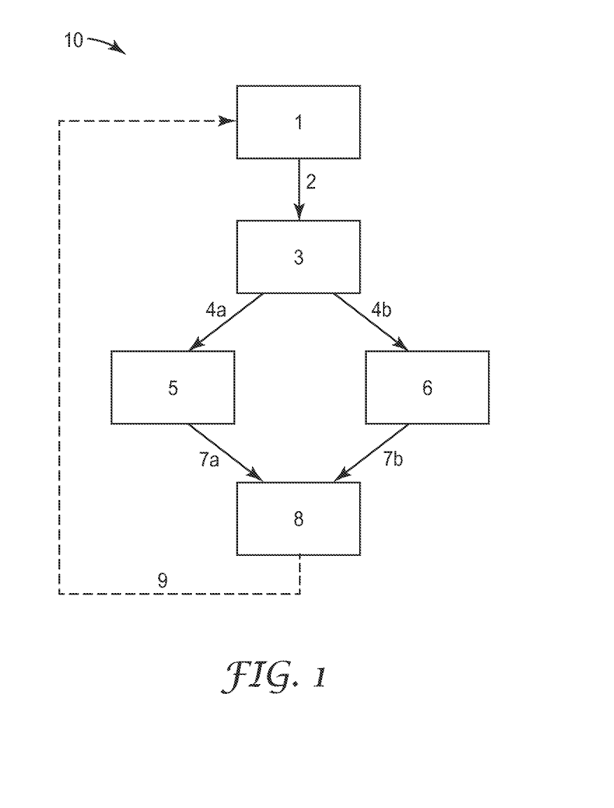

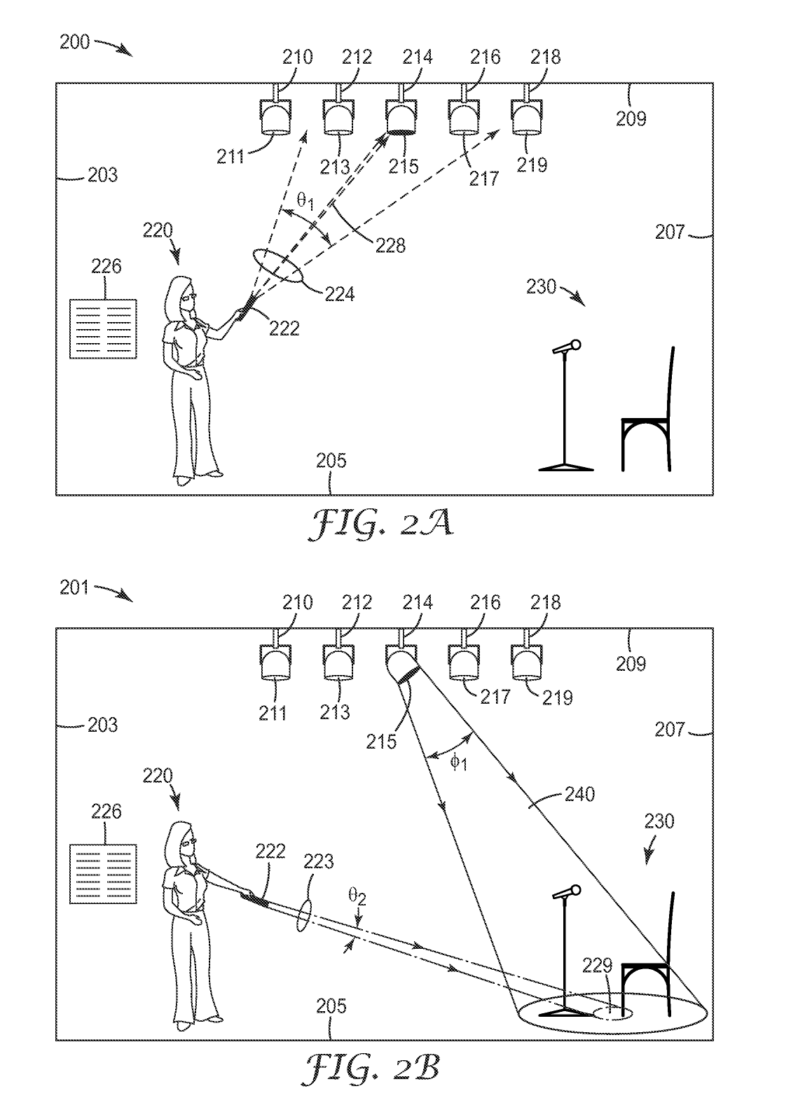

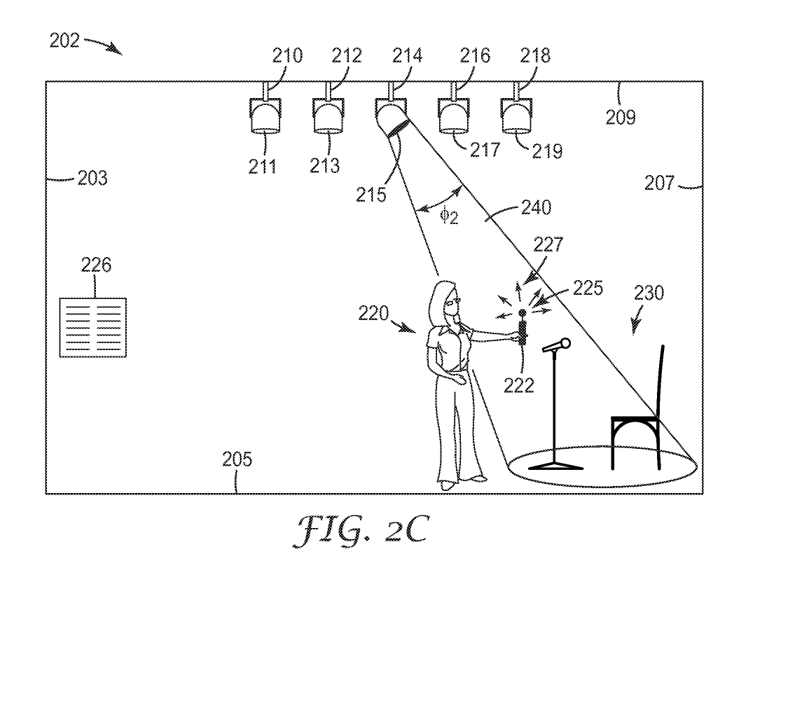

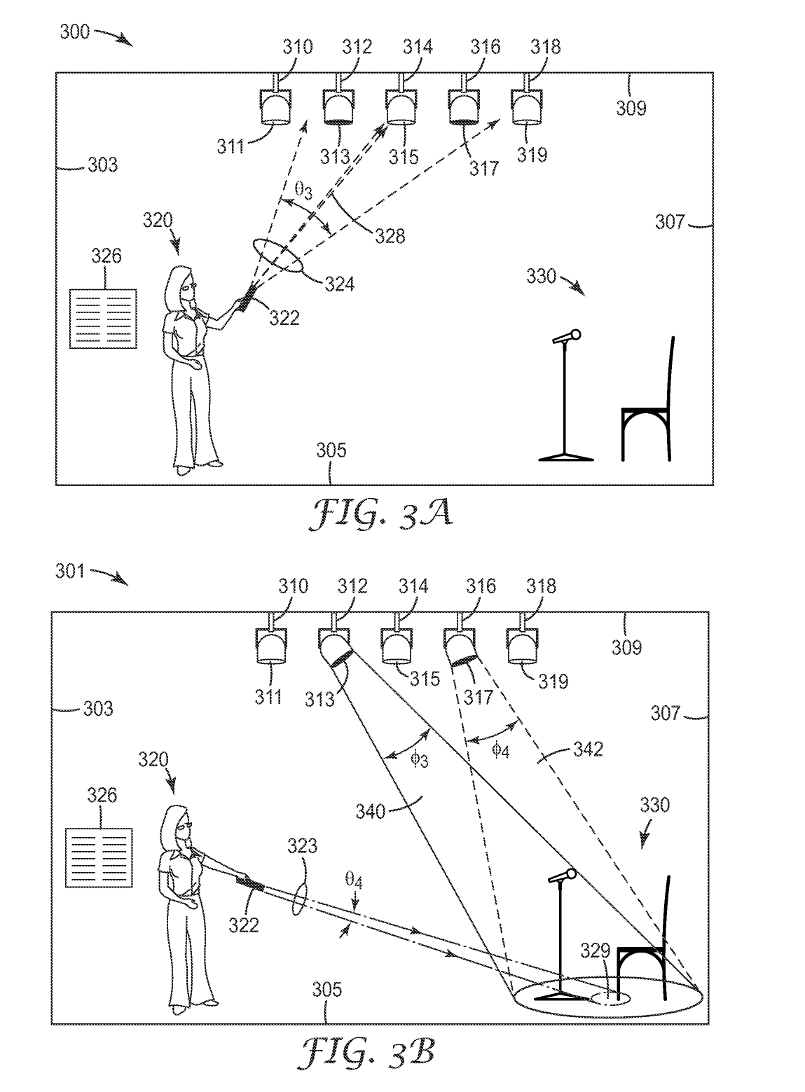

FIG. 1 shows a process schematic 10 of steps for controlling a spotlight, according to one aspect of the disclosure. In step 1, a control device is pointed toward a desired spotlight. Step 2 activates the desired spotlight with a first control beam from the control device. In step 3, the desired spotlight is selected after activation. Two different methods for directing the spotlight to a desired location then can take place, shown as branched steps 4a and 4b. In step 4a, the control device is pointed at an illumination region; in step 5, the illumination region is activated with a second control beam from the control device; and in step 7a, the activated spotlight moves toward the activated illumination region. Alternately, in step 4b, the control device having a beacon is moved to the illumination region; in step 6, the illumination region is activated with the beacon from the control device; and in step 7b, the activated spotlight moves toward the activated illumination region. In step 8, the activated spotlight shines on the activated illumination region, and in step 9, the activated spotlight is deactivated and the process begins again with a new desired spotlight. The steps are further illustrated and described with reference to FIGS. 2A-3B, which follow.

FIG. 2A shows a room 200 containing a lighting system for controlled spotlights, and a technique for controlling the spotlights, according to one aspect of the disclosure. Room 200 includes a floor 205, a front wall 203, a back wall 207, and a ceiling 209. Not shown are side walls enclosing the space within room 200. An illumination region 230 can be designated on the floor 205 as shown in the figure (e.g., adjacent a performers chair and microphone), or can be instead designated on front wall 203, back wall 207, or side walls (not shown), for example to illuminate a display, artwork, and the like. A plurality of spotlights, such as first, second, third, fourth and fifth spotlights 210, 212, 214, 216, 218 are suspended from the ceiling 209, and are adjacent each other in relatively close proximity. Each of the first through fifth spotlights, 210-218, can have an optional indicator, such as first, second, third, fourth, and fifth indicators 211, 213, 215, 217, 219, to inform a user 220 as to which of the first through fifth spotlights 210-218 have been activated.

The user 220 has a control device 222 that can be pointed toward at least one of the plurality of spotlights, and a first control beam 224 having a first beam angle θ1 illuminates one or more than one of the spotlights, such as the second, third, and fourth spotlights 212, 214, 216. In some cases, the first beam angle θ1 can be adjusted as desired to enable accurate spotlight selection; however, the separation distance of the user 220 from the spotlights on the ceiling 209 may cause the first control beam 224 to intercept more than one spotlight, so a selection among the spotlights may be necessary.

In one particular embodiment, the first control beam 224 can also include a higher intensity and/or a more tightly focused aiming light beam 228 to more readily indicate where the user is pointing, especially when the ceiling 209 is located far from the user 220, and the first control beam 224 may be difficult to see. In some cases, the aiming light beam 228 can be, for example, a separate high-intensity light source having a very small angular spread of light such as a laser located at the control device 222. In some cases, the aiming light beam 228 can instead be generated by an optical element placed over the beam to provide a “fuzzy” or less focused round spot, with a bright spot (i.e., the aiming light beam 228) located in the middle of the first control beam 224. In one particular embodiment, for example, a holographic optic that emits a circular beam of about 1 to 2 degrees, with a large portion of zero order punch through can be used. Any other suitable diffusive optics as known to one of skill in the art, can also be used.

The first control beam 224 activates the desired spotlight (in this case, third spotlight 214), and the corresponding optional indicator (in this case, third indicator 215) allows the user 220 to confirm that the desired spotlight has been activated. The room 200 further can include an optional electronic panel 226 that can be connected to the control device 222, the first through fifth spotlights 210, 212, 214, 216, 218, or both, to indicate the selection and progress of the alignment of the desired spotlight 214. In some cases, the optional electronic panel 226 can be a display, and can also communicate with the control device 222 and the first through fifth spotlights 210, 212, 214, 216, 218, by a wired connection, a wireless connection, or both a wired connection and a wireless connection.

The optional indicator (e.g., first through fifth indicator 211, 213, 215, 217, 219) can provide a feedback signal to the user 220 that can be an indicator light, a variable indicator light, an audible tone, a variable audible tone, an electronic signal, a wireless electronic signal, or a combination thereof. In some cases, the feedback signal can be located on the activated spotlight as shown in the figure, or the feedback signal can be located on the control device, on an electronic panel, on a display device, or on a combination thereof.

FIG. 2B shows a room 201 containing a lighting system for controlled spotlights, and a technique for controlling the spotlights, according to one aspect of the disclosure. In FIG. 2B, the control device 222 includes a second control beam 223 that is pointed at the illumination region 230, for example as described in FIG. 1, step 4a. Each of the elements 203-230 shown in FIG. 2B correspond to like-numbered elements 203-230 shown in FIG. 2A, which have been described previously. For example, illumination region 230 shown in FIG. 2B corresponds to illumination region 230 shown in FIG. 2A, and so on. In FIG. 2B, user 220 points control device 222 at illumination region 230, illuminates an aiming spot 229 using second control beam 223 having a second beam angle θ2, and activates illumination region 230. The second control beam 223 can generally include an intense and/or more tightly focused light, so that the selected spotlights can more readily seek and find the aiming spot 229.

Selected third spotlight 214 moves and pivots as described elsewhere, to center a third spotlight beam 240 having a third spotlight beam angle φ1 on the illumination region 230 that has been activated by the second control beam 223. The selected third spotlight 214 can then be de-selected by a timer (not shown) within a predetermined time after activation, when a different desired spotlight is activated, when the second control beam 223 is deactivated, by a switch or control on the control device 222, or by a combination thereof.

FIG. 2C shows a room 202 containing a lighting system for controlled spotlights, and a technique for controlling the spotlights, according to one aspect of the disclosure. In FIG. 2C, the control device 222 includes a beacon 225 that is positioned within the illumination region 230, for example as described in FIG. 1, step 4b. Each of the elements 203-230 shown in FIG. 2C correspond to like-numbered elements 203-230 shown in FIG. 2A, which have been described previously. For example, illumination region 230 shown in FIG. 2C corresponds to illumination region 230 shown in FIG. 2A, and so on. In FIG. 2C, user 220 moves to position control device 222 within illumination region 230, and activates illumination region 230 using a beacon 225 that emits a beacon control beam 227 across a wide range of angles. Selected third spotlight 214 moves and pivots as described elsewhere, to center a third spotlight beam 240 having a third spotlight beam angle φ2 on the illumination region 230 that has been activated by the beacon 225. The selected third spotlight 214 can then be de-selected by a timer (not shown) within a predetermined time after activation, when a different desired spotlight is activated, when the beacon 225 is deactivated, by a switch or control on the control device 222, or by a combination thereof.

FIG. 3A shows a room 300 containing a lighting system for controlled spotlights, and a technique for controlling the spotlights, according to one aspect of the disclosure. FIG. 3A shows selection and activation of more than one desired spotlight. Each of the elements 303-330 shown in FIG. 3A correspond to like-numbered elements 203-230 shown in FIG. 2A, which have been described previously. For example, illumination region 330 shown in FIG. 3A corresponds to illumination region 230 shown in FIG. 2A, and so on.

The user 320 has a control device 322 that can be pointed toward at least one of the plurality of spotlights, and a first control beam 324 having a first beam angle θ3 illuminates more than one of the spotlights, such as the second, third, and fourth spotlights 312, 314, 316. In some cases, the first beam angle θ3 can be adjusted as desired to enable accurate spotlight selection; however, the separation distance of the user 320 from the spotlights on the ceiling 309 may cause the first control beam 324 to intercept more than one spotlight, so a selection among the spotlights may be necessary.

As described elsewhere, the first control beam 324 can also include a higher intensity and/or a more tightly focused aiming light beam 328 to more readily indicate where the user is pointing, especially when the ceiling 309 is located far from the user 320, and the first control beam 324 may be difficult to see.

The first control beam 324 activates the desired spotlights (in this case, second spotlight 312 and fourth spotlight 316), and the corresponding optional indicators (in this case, second indicator 313 and fourth indicator 317) allows the user 320 to confirm that the desired spotlights have been activated.

FIG. 3B shows a room 301 containing a lighting system for controlled spotlights, and a technique for controlling the spotlights, according to one aspect of the disclosure. In FIG. 3B, the control device 322 includes a second control beam 323 that is pointed at the illumination region 330, for example as described in FIG. 1, step 4a. Each of the elements 303-330 shown in FIG. 3B correspond to like-numbered elements 203-230 shown in FIG. 2A, which have been described previously. For example, illumination region 330 shown in FIG. 3B corresponds to illumination region 230 shown in FIG. 2A, and so on. In FIG. 3B, user 320 points control device 322 at illumination region 330, illuminates an aiming spot 329 using second control beam 323 having a second beam angle θ4, and activates illumination region 330. The second control beam 323 can generally include an intense and/or more tightly focused light, so that the selected spotlights can more readily seek and find the aiming spot 329.

Selected second and fourth spotlights 312, 316, move and pivot as described elsewhere, to center both a second spotlight beam 340 having a second spotlight beam angle φ3 and a fourth spotlight beam 342 having a fourth spotlight beam angle φ4, on the illumination region 330 that has been activated by the second control beam 323. The selected second and fourth spotlight 312, 316, can then be de-selected by a timer (not shown) within a predetermined time after activation, when a different desired spotlight is activated, when the second control beam 323 is deactivated, by a switch or control on the control device 322, or by a combination thereof. Although not shown in a separate figure, it is to be understood that the positioning of the selected second and fourth spotlights 312, 316, can occur in a similar manner as shown with reference to FIG. 2C, where the control device 222 includes a beacon 225 that is positioned within the illumination region 230, for example as described in FIG. 1, step 4b.

Following are a list of embodiments of the present disclosure.

Item 1 is a method for spotlight control, comprising: pointing a control device toward a desired spotlight; activating the desired spotlight with a first control beam from the control device; pointing the control device at an illumination region; and activating the illumination region with a second control beam from the control device, wherein the activated spotlight moves to illuminate the activated illumination region.

Item 2 is the method of item 1, wherein the desired spotlight is adjacent undesired spotlights.

Item 3 is the method of item 1 or item 2, wherein activating the desired spotlight includes generating a feedback signal to indicate activation.

Item 4 is the method of item 3, wherein the feedback signal comprises an indicator light, a variable indicator light, an audible tone, a variable audible tone, an electronic signal, a wireless electronic signal, or a combination thereof.

Item 5 is the method of item 4, wherein the feedback signal is located on the activated spotlight, on the control device, on an electronic panel, on a display device, or on a combination thereof.

Item 6 is the method of item 1 to item 5, wherein a timer deactivates the activated spotlight a predetermined time after activation.

Item 7 is the method of item 1 to item 6, wherein the activated spotlight becomes deactivated when a different desired spotlight is activated.

Item 8 is the method of item 1 to item 7, wherein the activated spotlight becomes deactivated when the second control beam is deactivated.

Item 9 is the method of item 1 to item 8, wherein a third control beam from the control device controls spotlight features comprising dimming, color, beam shape, edge sharpness, and the like.

Item 10 is the method of item 1 to item 9, wherein the desired spotlight comprises at least one sensor for sensing the first control beam and the second control beam.

Item 11 is the method of item 1 to item 10, wherein the desired spotlight comprises a position sensitive sensor providing a signal for moving the activated spotlight toward the second control beam.

Item 12 is the method of item 1 to item 11, wherein the first control beam and the second control beam comprise different wavelengths of light, different light pulse patterns, different audible tones, different audible tone patterns, different wireless signals, or a combination thereof.

Item 13 is the method of item 1 to item 12, wherein the first control beam comprises a first narrow wavelength band of light, and the second control beam comprises a second narrow wavelength band of light different from the first narrow wavelength band of light.

Item 14 is the method of item 13, wherein the desired spotlight comprises a first sensor filtered to detect the first narrow wavelength band of light, and a second sensor filtered to detect the second narrow wavelength band of light.

Item 15 is the method of item 1 to item 14, wherein the control device further comprises at least one of an accelerometer capable of detecting motions, or a second selector switch, to control the desired spotlight positioning, dimming, color, beam shape, edge sharpness, and the like.

Item 16 is the method of item 1 to item 15, wherein the desired spotlight comprises more than one spotlight.

Item 17 is the method of item 1 to item 16, wherein the control device further comprises a beacon capable of being positioned in the illumination region, wherein the activated spotlight follows the beacon to illuminate the activated illumination region.

Item 18 is a method for spotlight control, comprising: pointing a control device toward a desired spotlight; activating the desired spotlight with a first control beam from the control device; activating a beacon; and positioning the beacon in an illumination region, wherein the activated spotlight follows the beacon to illuminate the activated illumination region.

Item 19 is the method of item 18, wherein the desired spotlight is adjacent undesired spotlights.

Item 20 is the method of item 18 or item 19, wherein activating the desired spotlight includes generating a feedback signal to indicate activation.

Item 21 is the method of item 19, wherein the feedback signal comprises an indicator light, a variable indicator light, an audible tone, a variable audible tone, an electronic signal, a wireless electronic signal, or a combination thereof.

Item 22 is the method of item 19, wherein the feedback signal is located on the activated spotlight, on the control device, on an electronic panel, on a display device, or on a combination thereof.

Item 23 is the method of item 18 to item 22, wherein a timer deactivates the activated spotlight a predetermined time after activation.

Item 24 is the method of item 18 to item 22, wherein the activated spotlight becomes deactivated when a different desired spotlight is activated.

Item 25 is the method of item 18 to item 24, wherein the activated spotlight becomes deactivated when the beacon is deactivated.

Item 26 is the method of item 18 to item 25, wherein a third control beam from the control device controls spotlight features comprising dimming, color, beam shape, edge sharpness, and the like.

Item 27 is the method of item 18 to item 26, wherein the desired spotlight comprises at least one sensor for sensing the first control beam and the beacon.

Item 28 is the method of item 18 to item 27, wherein the desired spotlight comprises a position sensitive sensor providing a signal for moving the activated spotlight toward the beacon.

Item 29 is the method of item 18 to item 22, wherein the first control beam and the beacon comprise different wavelengths of light, different light pulse patterns, different audible tones, different audible tone patterns, different wireless signals, or a combination thereof.

Item 30 is the method of item 18 to item 29, wherein the first control beam comprises a first narrow wavelength band of light, and the second control beam comprises a second narrow wavelength band of light different from the first narrow wavelength band of light.

Item 31 is the method of item 18 to item 30, wherein the desired spotlight comprises a first sensor filtered to detect the first narrow wavelength band of light, and a second sensor filtered to detect the second narrow wavelength band of light.

Item 32 is the method of item 18 to item 31, wherein the control device further comprises at least one of an accelerometer capable of detecting motions, or a second selector switch, to control the desired spotlight positioning, dimming, color, beam shape, edge sharpness, and the like.

Item 33 is the method of item 18 to item 32, wherein the desired spotlight comprises more than one spotlight.

Item 34 is the method of item 18 to item 33, wherein the control device further comprises a second control beam capable of illuminating and activating the illumination region, wherein the activated spotlight moves to illuminate the activated illumination region.

Item 35 is a spotlight control device, comprising: a first light source capable of emitting a first wavelength of light collimated within a first beam angle; a second light source capable of emitting a second wavelength of light; and a selector switch capable of selecting the first light source or selecting the second light source.

Item 36 is the spotlight control device of item 35, wherein the second light source is collimated within a second beam angle.

Item 37 is the spotlight control device of item 36, wherein the first beam angle is greater than the second beam angle.

Item 38 is the spotlight control device of item 35 to item 37, wherein the second light source is a beacon.

Item 39 is the spotlight control device of item 35 to item 38, wherein at least one of selecting the first light source or selecting the second light source comprises pulsing the selected light source.

Item 40 is the spotlight control device of item 35 to item 39, further comprising at least one of an accelerometer capable of detecting motions, or a second selector switch, to control the desired spotlight positioning, dimming, color, beam shape, edge sharpness, and the like.

Item 41 is a lighting system, comprising: at least one spotlight, comprising: a first sensor filtered to detect a first narrow wavelength band of light to activate a selected spotlight; a second sensor filtered to detect a second narrow wavelength band of light incident on the selected spotlight; a mechanism to move the selected spotlight in alignment with a light source having the second narrow wavelength band of light; and a spotlight control device capable of illuminating the first sensor with the first narrow wavelength band of light and the second sensor with the second narrow wavelength band of light, wherein the light source having the second narrow wavelength band of light is in an illumination region.

Item 42 is the lighting system of item 41, wherein the light source having the second narrow wavelength band of light is selected from a beacon in the illumination region, or reflected light from the illumination region.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof

What is claimed is:

1. A method for spotlight control, comprising:
pointing a control device toward a desired spotlight;
activating the desired spotlight with a first control beam from the control device;
pointing the control device at an illumination region; and
activating the illumination region with a second control beam from the control device, wherein the activated spotlight moves to illuminate the activated illumination region.

2. The method of claim 1, wherein the desired spotlight is adjacent undesired spotlights.

3. The method of claim 1, wherein activating the desired spotlight includes generating a feedback signal to indicate activation.

4. The method of claim 3, wherein the feedback signal comprises an indicator light, a variable indicator light, an audible tone, a variable audible tone, an electronic signal, a wireless electronic signal, or a combination thereof.

5. The method of claim 4, wherein the feedback signal is located on the activated spotlight, on the control device, on an electronic panel, on a display device, or on a combination thereof.

6. The method of claim 1, wherein a timer deactivates the activated spotlight a predetermined time after activation.

7. The method of claim 1, wherein the activated spotlight becomes deactivated when a different desired spotlight is activated.

8. The method of claim 1, wherein the activated spotlight becomes deactivated when the second control beam is deactivated.

9. The method of claim 1, wherein a third control beam from the control device controls spotlight features comprising dimming, color, beam shape, edge sharpness, and the like.

10. The method of claim 1, wherein the desired spotlight comprises at least one sensor for sensing the first control beam and the second control beam.

11. The method of claim 1, wherein the desired spotlight comprises a position sensitive sensor providing a signal for moving the activated spotlight toward the second control beam.

12. The method of claim 1, wherein the first control beam and the second control beam comprise different wavelengths of light, different light pulse patterns, different audible tones, different audible tone patterns, different wireless signals, or a combination thereof.

13. The method of claim 1, wherein the first control beam comprises a first narrow wavelength band of light, and the second control beam comprises a second narrow wavelength band of light different from the first narrow wavelength band of light.

14. The method of claim 13, wherein the desired spotlight comprises a first sensor filtered to detect the first narrow wavelength band of light, and a second sensor filtered to detect the second narrow wavelength band of light.

15. The method of claim 1, wherein the control device further comprises at least one of an accelerometer capable of detecting motions, or a second selector switch, to control the desired spotlight positioning, dimming, color, beam shape, edge sharpness, and the like.

16. The method of claim 1, wherein the desired spotlight comprises more than one spotlight.

17. The method of claim 1, wherein the control device further comprises a beacon capable of being positioned in the illumination region, wherein the activated spotlight follows the beacon to illuminate the activated illumination region.

18. A method for spotlight control, comprising:
pointing a control device toward a desired spotlight;
activating the desired spotlight with a first control beam from the control device;
activating a beacon; and
positioning the beacon in an illumination region, wherein the activated spotlight follows the beacon to illuminate the activated illumination region.

19. The method of claim 18, wherein the desired spotlight is adjacent undesired spotlights.

20. The method of claim 18, wherein activating the desired spotlight includes generating a feedback signal to indicate activation.

21. The method of claim 20, wherein the feedback signal comprises an indicator light, a variable indicator light, an audible tone, a variable audible tone, an electronic signal, a wireless electronic signal, or a combination thereof.

22. The method of claim 20, wherein the feedback signal is located on the activated spotlight, on the control device, on an electronic panel, on a display device, or on a combination thereof.

23. The method of claim 18, wherein a timer deactivates the activated spotlight a predetermined time after activation.

24. The method of claim 18, wherein the activated spotlight becomes deactivated when a different desired spotlight is activated.

25. The method of claim 18, wherein the activated spotlight becomes deactivated when the beacon is deactivated.

26. The method of claim 18, wherein a third control beam from the control device controls spotlight features comprising dimming, color, beam shape, edge sharpness, and the like.

27. The method of claim 18, wherein the desired spotlight comprises at least one sensor for sensing the first control beam and the beacon.

28. The method of claim 18, wherein the desired spotlight comprises a position sensitive sensor providing a signal for moving the activated spotlight toward the beacon.

29. The method of claim 18, wherein the first control beam and the beacon comprise different wavelengths of light, different light pulse patterns, different audible tones, different audible tone patterns, different wireless signals, or a combination thereof.

30. The method of claim 18, wherein the first control beam comprises a first narrow wavelength band of light, and the second control beam comprises a second narrow wavelength band of light different from the first narrow wavelength band of light.

31. The method of claim 30, wherein the desired spotlight comprises a first sensor filtered to detect the first narrow wavelength band of light, and a second sensor filtered to detect the second narrow wavelength band of light.

32. The method of claim 18, wherein the control device further comprises at least one of an accelerometer capable of detecting motions, or a second selector switch, to control the desired spotlight positioning, dimming, color, beam shape, edge sharpness, and the like.

33. The method of claim 18, wherein the desired spotlight comprises more than one spotlight.

34. The method of claim 18, wherein the control device further comprises a second control beam capable of illuminating and activating the illumination region, wherein the activated spotlight moves to illuminate the activated illumination region.

35. A spotlight control device, comprising:
a first light source capable of emitting a first wavelength of light collimated within a first beam angle;
a second light source capable of emitting a second wavelength of light; and
a selector switch capable of selecting the first light source or selecting the second light source.

36. The spotlight control device of claim 35, wherein the second light source is collimated within a second beam angle.

37. The spotlight control device of claim 36, wherein the first beam angle is greater than the second beam angle.

38. The spotlight control device of claim 35, wherein the second light source is a beacon.

39. The spotlight control device of claim 35, wherein at least one of selecting the first light source or selecting the second light source comprises pulsing the selected light source.

40. The spotlight control device of claim 35, further comprising at least one of an accelerometer capable of detecting motions, or a second selector switch, to control the desired spotlight positioning, dimming, color, beam shape, edge sharpness, and the like.

41. A lighting system, comprising:
at least one spotlight, comprising:
a first sensor filtered to detect a first narrow wavelength band of light to activate a selected spotlight;
a second sensor filtered to detect a second narrow wavelength band of light incident on the selected spotlight;
a mechanism to move the selected spotlight in alignment with a light source having the second narrow wavelength band of light; and
a spotlight control device capable of illuminating the first sensor with the first narrow wavelength band of light and the second sensor with the second narrow wavelength band of light, wherein the light source having the second narrow wavelength band of light is in an illumination region.

42. The lighting system of claim 41, wherein the light source having the second narrow wavelength band of light is selected from a beacon in the illumination region, or reflected light from the illumination region.
